(19) United States
(12) Patent Application Publication
(10) Pub. No.: US 2007/0276776 A1
(43) Pub. Date: Nov. 29, 2007

(54) User trainable detection apparatus and method

(75) Inventors: Yoram Sagher, Tel-Aiv (IL); Ronen Saggir, Rishon-LeZion (IL); Moshe Butman, Petach-Tikva (IL)

Correspondence Address: Martin D. Moynihan;PRTSI, Inc., P.O. Box 16446, Arlington, VA, 22215, US

(73) Assignee: Vigilant Technology Ltd., Tel-Aviv (IL)

(21) Appl. No.: 11/598,059

(22) Filed: Nov. 13, 2006

Related U.S. Application Data
(60) Provisional application No. 60/802,771, filed on May 24, 2006.

(51) Int. Cl. G06N 3/08

(52) U.S. Cl. 706/25

(57) ABSTRACT

A user trainable detecting apparatus for on site configuration comprises: one or more sensors; a detector for detecting events within the data arriving from the sensor, and a user interface that has labeling functionality, and which enables the user to label data from the sensor through the interface. A learning unit uses the labeled data for in-situ learning for use in the detector.

### RELATED APPLICATIONS

The present application claims priority from U.S. Provisional Patent Application No. 60/802,771, filed on May 24, 2006, the contents of which are incorporated herein by reference.

### FIELD AND BACKGROUND OF THE INVENTION

The present invention relates to a general purpose detection apparatus and more particularly, but not exclusively, to a user trained general purpose detection apparatus and method.

Currently known detecting technology uses primarily special purpose detecting devices, which are used to address a specific detection application. Smoke detectors, pressure detectors, burglary detectors, face detectors, motion detectors and industrial inspection detectors are some examples of a wide range of detecting devices. Some of the special purpose detecting devices, such as smoke detectors, pressure detectors and burglary detectors, are easy to implement, inexpensive and provide an adequate solution to the particular detection problem, while other detecting devices, such as face detectors, are more involved, include one or more cameras and a processor for analyzing the image data.

The advances of recent years in sensor and processing technologies have led to the introduction of detecting devices capable of dealing with added complexity detection problems.

The discussion in the subsequent section is mostly related to video imaging examples. It should be noted however that the subject matter is not limited to video detectors but can be related to other kind of detectors as well.

Object tracking applications, for instance, such as surveillance or traffic control and management applications, require the use of unattended detection of events by utilizing vision sensors and massive amounts of vision data, which can then be used by an image processing algorithm to enhance the knowledge of the event without supervision. Existing detecting devices typically provide tools for quick image data acquisition and preliminary processing of image-processing software algorithms for enhancing processing speed and hence respond to events momentarily. The changing dynamic nature of events puts a heavy burden on the image-processing algorithms and often yields inadequate performance. Furthermore, these detecting devices have a significant handicap in their capability to adapt to changing conditions, such as when camera positions change and additional calibration may be required for the new camera position.

Though there has been significant progress in event detectors, enhancement of their performance and uncomplicated adaptation to varying conditions are still highly desired. In recent years only a limited number of systems, capable of detecting suspicious events, have been introduced. One of the problems associated with these systems is that they are designed to work with predefined limited conditions. Examples include fixed camera positions such as: top view cameras in hallways or side view cameras in building entries which tend to see very similar images or systems designed to work with predefined scenarios, say of a running person or deposited baggage in certain lighting conditions.

Real detection problems are particular by nature and it is not realistic to rely on pre-determined conditions which are general by nature. An outcome of the limited ability to handle a variety of detection conditions is a limited use of current detection technology event detectors.

General purpose detectors that have widespread use do not exist yet. More complex detection problems may be addressed by using several detectors combined. This complicates the system considerably and raises the cost. A generic platform capable of executing a large variety of detection tasks is not available yet.

Detection problems are based on events. These may be events of interest or events that may be regarded as suspicious. It is possible to define the kind of event it is necessary to detect. Some of the different kinds of events which may be associated with detection problems are discussed as follows:

I. Change of Outline Event

An object enters a Region Of Interest (ROI) and stays there for an extended period of time. For instance: A bag is left in a busy hallway, or a car is parked in a secured zone where parking is banned. Included in this event type are inverse occurrences wherein an object disappears from the ROI, for example: the theft of a painting from a museum or an expensive pen from a desk.

II. Change of Direction Outline Event

An object of a certain kind moves opposite to a predefined direction. Examples which include: a car driven on the highway in the opposite direction, a person walking suspiciously in an airplane sleeve in the opposite direction to that of the rest of the people, require attention of security authorities.

III. Suspicious Color Event

A suspicious object of a predefined color enters an ROI. For example a red car enters the scene and is detected following a warning that a runaway red car has been reported.

IV. Object Tracking.

An object labeled by the user or by a security system is followed continuously. An example includes: following a suspicious person in a stairway for alerting the security guard.

An unattended detector for this kind of event is structured to mark an area, say an ellipse, to define the object and moves the ellipse to accompany movement of the object.

V. Face Detection

Given an image or video, one would wish to find whether there are faces in a specific frame and give their location.

VI Pedestrian Detection

A commonly desired application of object finding and tracking is pedestrian finding and tracking, namely to identify whether there are pedestrians in a particular frame and to give their locations.

VII. Sound Detecting

A suspicious sound event may be of interest to security personnel. The suspicious sound event may be for example: a shot sound or a scream sound.

An unattended detector of this event comprises a sound sensor rather than a camera and is structured for analyzing sound waveforms, and issues an alert whenever a suspicious sound is detected.

It will be appreciated that the above problems are not unique to the surveillance world, and can be demonstrated in other fields. For instance, the problem of detecting a misplaced object in an ROI is similar to detecting tumors in a medical imaging system or spotting patterns in heart waveform measurements.

Recently there have been various attempts to produce general purpose detectors, wherein a single device can address a variety of sensors and applications. In particular there have been attempts to produce a general solution to the computer vision problem.

Generalization of a detector is a sensible measure to apply as technology progresses, yet the attempts have been only marginally successful so far due to the difficulty presented by the generality of the detection problems. It is the generality of the problem which has mostly been problematic, rather than any specific weakness of the algorithms used.

The performance of present general purpose detectors is inadequate due to the trade-off between miss detection and false alarm rate. A practical required level of miss detection leads to a high level of false alarm rate which is particularly detrimental when a large system is controlling a multiplicity of detectors. The false alarm rate of the entire system is determined by multiplying the false alarm rate of a single detecting device by the number of detecting devices in the system. For instance, even when the false alarm rate of a detecting device is one per day with a single sensor, the false alarm rate of a system including 1000 sensors is 1000 per day, a false alarm rate that is too high to be acceptable. The use of multiple sensors for a given detector is a measure that can be taken to improve detector performance since each sensor feature, if suitably selected, can add orthogonally to level of detection. Combined detected features from non-related sensors can improve the quality of detection and thus reduce the false alarm rate. However, the poor performance of current technology in handling multiple sensors defeats this scheme of detector improvement.

The complex algorithms of the present general purpose detector and the real time response requirement impose the choice of a powerful computer or dedicated hardware platforms, which evidently increase the cost of the detector.

Current learning machine based detectors are calibrated once by a predefined set of examples in the development laboratory. This limits their performance because the set of examples used for calibration that rarely represents the sensor input data at the user site.

Performance of current detectors does not improve over use despite the fact that the devices are exposed to various events and scenarios that have not been included in the original calibration procedure.

One of the problems of the present general purpose detecting devices is the capability to adjust to varying conditions. The devices which are calibrated once, by using a predefined calibration set, have no methodology of further improvement or adjustment to varying conditions. One variable condition of a detection problem is the detection scene. Though the application of the detecting problem may be invariable, the scene may vary over time for any given detection problem. Varying conditions require program modifications or recalibration of system parameters and need to be carried out at the customer site by skilled personnel. Another variable factor involves newly emerging sensor technologies. Since detecting devices include a processor connected to one or more sensors, changes of sensor technology require applying of changes to the detector. Implementing those changes might be time consuming and costly.

A higher product cost is incurred by the substantial R&D effort involved in trying to solve the complex general purpose product modification process, including: programming, testing and calibration by R&D personnel.

The present general purpose detectors are not cost effective due to the drawbacks discussed above. The costly computers or hardware platform required, the complex algorithms that need to be developed and the extensive device calibration routines carried out by the R&D department, add considerably to device cost.

Integrating a system combined of several detectors may be a complex and expensive task with the present technology, since the differently configured detectors are provided by different vendors, each having a specialty in a certain detection field and implementing a specific design.

The high cost associated with the general detection problem leads to an expensive device unaffordable by home users as well as by higher end users. High end users needing typically an integrated system of 1000 channels, utilize typically only 10 detectors in the system. When a user needs to configure several detectors to operate simultaneously in one system, he faces a complex integration task. Different detectors are purchased from different vendors specializing in different fields and the detectors are not designed to interface and work together. Consequently, integration is intricate and costly.

The detector should be able to add easily new detecting tasks and new sensors without having to carry out a long and complex recalibration. Furthermore, general purpose detectors should be able to enhance performance as they gain experience of new detection cases. The operator, who lacks the capability to define new features for the detector, should not have to be involved in the enhancement process.

There is no direct feedback from the user about the performance of the detecting device. Each user complaint has to be reported to the service department when recalibration is needed or to the R&D department to develop a better solution.

Present general purpose detectors have a substantially long introduction time for new features, technologies and user requirements, due to limited flexibility. General purpose detectors should be able to apply new innovations and developments in the detection field and promptly integrate them into large systems incorporating multiplicity of devices.

The higher complexity algorithms needed for the current detection technology lengthen the product development process. Integrating and testing of the complex algorithm to obtain an adequate performance level further increases development time. System testing procedures also become lengthy. Devising specifications from user requirements may be substantially lengthy in time since frequently those needs are not clear to the user himself. Complex scenarios lead to difficulty in the user explaining the scenario to the R&D people, and in the R&D department understanding and reproducing the scenario.

Many sensors are currently available and used for a variety of detection problems, like for example: A video sensor, an audio sensor, barometer and radiometer. Each one has a unique sensing capability. Frequently several sensors have to be combined into solving a detection problem. Incorporating several sensors with a single detector enables a robust performance of the detector. Easy incorporation of various sensors provides a large feature space for event definition, and is therefore desirable.

It is not easy to integrate new sensors in existing systems without damaging performance. Furthermore, as technology progresses, new sensor and detecting technologies emerge. Combining new sensor technologies into a system to provide solutions to a large variety of detection problems, and enhancing detection performance, is highly desired. New sensors are required to be easily integrated into existing systems without having negative effect on the performance.

An added complexity is attributed to connecting a multiplicity of sensors to one detection device which requires a complex manual calibration procedure. The calibration procedure has to be implemented by highly skilled personnel and therefore carries a high price tag. Miscalibration of the detector can lead to poor performance.

The general purpose detectors of the current technology are not really entirely general even though intended to be general purpose detectors in some respect. They provide special solutions to specific problems such as for instance: a face detector provides a solution for identifying human faces, and the same detector cannot be used for developing new detectors. A solution to a new problem has to be devised by integration of previously developed detecting devices or by developing new components for existing devices. A new detector can take several years to develop and requires substantial manpower to be involved. Client-developer mis-understandings related to the detector specification generally lead to adjustments required after the detector installation. A new detection problem may lead to combining several existing detectors to avoid a lengthy development time.

In many instances detectors are typically incorporated into bigger systems. The integration of a detector with other system components should be simplified by incorporating a standard interface into the detector. The general purpose detector has to interface a wide selection of sensors such as for instance, video cameras, infrared imagers, smoke detectors and pressure sensors. The detector has to interface also other components of the system, determined by the application, such as for instance, access control systems, fences and alarm systems. System integration can be made easy by using a standard, well defined Application Programming Interface (API) common to all the system components. Frequently several detectors have to be integrated to provide a solution. Since different detectors are supplied by different vendors, a non standard system interface makes the integration much harder.

Each vendor provides a specific API for his own detectors/sensors and the APIs of the different vendors are not compatible. Many detectors are integrated into large scale systems, and users often expect different detectors to operate together. Since detectors are special products developed separately in each company, integration takes lots of time and money to implement.

Confidentiality is another major issue with detecting devices. Exposing operational requirements to the device developer, presents a security hazard which concerns device users. A possible answer to the security concerns may be provided by configuring the detecting device at the user site, by authorized personnel, without exposing the specifications for the detector of the user to the developer. However a difficulty arises in finding skilled personnel who are not connected with the developer. Nevertheless, when modifications in system operation are required and the user has the capability of implementing them again on site by authorized personnel, time can be saved and confidentiality retained.

A high performance detector has to feature a low probability of false alarm while maintaining a high probability of detection. Subjecting the security personnel to frequent false alarm rates may be costly and generate a negative attitude by the security personnel towards the detector.

Detectors have to keep up with on going changes attributable to changing scenarios or operating conditions and without the costly involvement of the detector provider.

The requirement of providing a prompt solution to any new detection is highly desirable and the detector should preferably provide real time or near real time performance.

The price of current detectors amounts to several hundred dollars per sensor.

This price is derived from R&D, production and marketing costs. The development of a new detector is cost effective when the detector is sold in large quantities. The ideal detector has to be capable of addressing different user requirements without having to go through a full development cycle for different detector applications. A general purpose detector can provide a cost effective solution even to very specific and narrowly used detection problems. A low cost detector able to solve any detection problem, is the ideal. Though the initial development cost of this type of detector may be high, the widespread applications of the detector provide in the end, a cost effective solution.

Another desired detector feature is ease of use, meaning that no special configuration menus should be required and operation should be straightforward and intuitive as possible. Plug and play abilities as home computers do and operation handled without user intervention is desired. Since detectors are operated by security personnel, who ordinarily have limited knowledge of operating computer controlled devices, detector performance should not be dependent on the operator skills. The detector should be able to be adapted to new requirements. A prompt adaptation capability enables the detector to integrate quickly fast technology changes. New innovations and technology enhancements should be easy to implement, new detection tasks easily incorporated and changing requirements supported without having to install new components.

One of the intricacies of unattended event detection is the broad scope of the problem. Consequently, existing event detectors require extensive human intervention during configuration. Manual calibration limits system flexibility and performance. Furthermore, since the image processing algorithms provide only a limited detection capability, a human operator is usually involved in the detection process. Human operator involvement includes for instance, specifying a prohibited area to be monitored by a security system. Operational parameters may have to be entered by the operator prior to and during every shift of operation, depending on the application.

The detector should be able to enhance operation without user intervention. Detailed definition of detector requirements is a demanding task frequently yielding inadequate detector definition and hence poor detector performance. Therefore it is desired that the detector shipped to the user, should not be configured by the manufacturer but rather be configured by the user using scenarios of real data and be able to adapt the performance for new scenarios or new requirements.

Another desirable feature of the detector is quick delivery. Tracking the fast changing technology is one aspect of quick product delivery. The versatility of the detector to adapt to different user needs is another aspect of quick delivery. New innovations and technology enhancements should be easily and quickly integrated into the system by a detector design and changes adapted quickly, and a way of doing this does not currently exist. The detector is preferably a software product so that product changes can be applied faster.

An ideal situation would be to have a general purpose detection apparatus that is easily configurable, easily adaptable to varying conditions, easily configurable into large systems, utilizing a single generic platform, maintaining confidentiality and inexpensive.

### SUMMARY OF THE INVENTION

According to one aspect of the present invention there is provided a user trainable detecting apparatus for on site configuration; said apparatus comprising:

at least one sensor;

a detector for detecting events in data from said sensor, a user interface with labeling functionality, to enable said user to label, data from said sensor; and

a learning unit, associated with said user interface, to use said labeled data in an in-situ learning process to produce an in-situ learning result for use in said detector.

According to a second aspect of the present invention there is provided a user trainable detecting method comprising:

placing a sensor in situ;

obtaining from said sensor an initial set of real data;

passing said initial set of data to a user interface;

at said user interface accepting user labeling of said data;

carrying out a learning process using said labeled data to produce an in situ learning result; and

using said in situ learning result to carry out recognition of further data obtained from said in-situ sensor.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of the user trainable detection apparatus according to a preferred embodiment of the invention;

FIG. 2 is a block diagram of the learning unit operation according to a preferred embodiment of the invention;

FIG. 3 is a block diagram of the learning cycle according to a preferred embodiment of the present invention;

FIG. 4 is a block diagram of the Learning Detector Builder according to a preferred embodiment of the present invention;

FIG. 5 is a block diagram of the User Detector structure according to a preferred embodiment of the present invention;

FIG. 6 is a block diagram of a tractor detector example according to a preferred embodiment of the present invention;

FIG. 7 is a block diagram of a favorite music detector example according to a preferred embodiment of the present invention;

FIG. 8 is an illustration of the learning process of a tractor detector example according to a preferred embodiment of the present invention;

FIG. 9 is an illustration of user interface screens of the tractor detector example, featuring three learning processes, according to a preferred embodiment of the present invention;

FIG. 10 is a block diagram of the learning detector builder according to a preferred embodiment of the present invention;

FIG. 11 is a block diagram of an element process according to a preferred embodiment of the present invention;

FIG. 12 is a detailed block diagram of a user detector according to a preferred embodiment of the present invention;

FIG. 13 is a block diagram of hierarchical learning according to a preferred embodiment of the present invention;

FIG. 14 is an illustration of an Artificial Neural Network;

FIG. 15 is an illustration of a support vector machine;

FIG. 16 is an illustration of detector user interface screens of a moving car detected event example, according to a preferred embodiment of the present invention;

FIG. 17 is an illustration of detector user interface screens of a tractor detector example according to a preferred embodiment of the present invention;

FIG. 18 is an illustration of detector user interface screens of a face detector example according to a preferred embodiment of the present invention;

FIG. 19 is an illustration of detector user interface screens of a clock theft detector example according to a preferred embodiment of the present invention; and

FIG. 20 is an illustration of detector user interface screens of a moving tractor detector according to a preferred embodiment of the present invention.

### DESCRIPTION OF THE PREFERRED EMBODIMENTS

The present embodiments redefine event detection capability by disclosing a general purpose detector which has an interface to allow it to be configured by the user at the user site for the user-specific detection problem. The user configuration is enhanced by a learning process, to produce an is-situ learning result which is a result based on in situ-date obtained by the sensor or sensors. A single platform is provided which is capable of receiving inputs of a multiplicity of sensors substantially unlimited in variety and following customization, is able to provide a solution to a substantially unlimited number of specific event detection problems. The interface is preferably intuitive.

The present embodiments provide inter alia a set of tools which enable the user to create a detector based on one or more sensors using a semi-automatic machine learning process.

The platform comprises a learning block and a detector block, and provides a multi-sensor detector providing high performance detecting capability for the user-specific problem. The learning block uses labeled examples provided by the user through the interface in order to provide assisted learning. In one embodiment, the learning block (also called: Learning Detector Builder) uses the labeled examples to create a set of classifiers and hypotheses to seed a learning process.

The detector block (also called: user detector) implements a user specific detector based on the output hypothesis of the learning block. The detector identifies a certain event/object based on the output hypothesis of the learning block, and ascribes it to one of a selection of predefined classes.

The higher the number of labeled examples entered by the user to the system, during the learning process, the better is performance of the detector. This learning process is iterative and may be continued after the detector begins regular operation by utilizing additional learning examples, where the additional examples can come from output of the detector for improvement of performance.

The concept can be applied to substantially unlimited types of input sensors and combinations of sensors, including: video, audio, thermometer and all of these can be connected to the single detector.

In the presently preferred embodiments, examples are fed into the system at the user site. Using the training set of examples at the user site enhances the system robustness, since the system has to deal with a reduced set of examples, specific to his detection problem. For example: a training set of a face detector at a user site consists of a significantly reduced number of faces comprising the detected data set, compared to the case of a generic face detector. The set of faces of a generic face detector includes a large set of faces. Taken at the user site, the faces are typically a much reduced set of resolutions, qualities, sizes, etc. The limited scope of detected instances at the user site, allows creation of a higher performance detector through an on site learning process.

Though most examples used for the learning process may be live data input examples obtained from sensors and labeled by the user, detector learning process is not limited to live data and can use pre-recorded examples as well.

The process according to preferred embodiments of the present invention proceeds as following:

Initially, the system has no knowledge and no input. The sensor receives data and the user makes use of the incoming data to create an initial set of examples for his own detection problem by using a Graphical User Interface (GUI), typically based on a general purpose computer, for marking (called also: labeling) the objects of interest and objects that have to be excluded.

The system uses the labeled data to automatically create a classifier for each object. The user operates the detector (also called: User detector) on real system inputs and examines system performance.

The user may feed into the system harder examples that are misclassified by the detector.

The process may be repeated iteratively until the performance of the system becomes satisfactory.

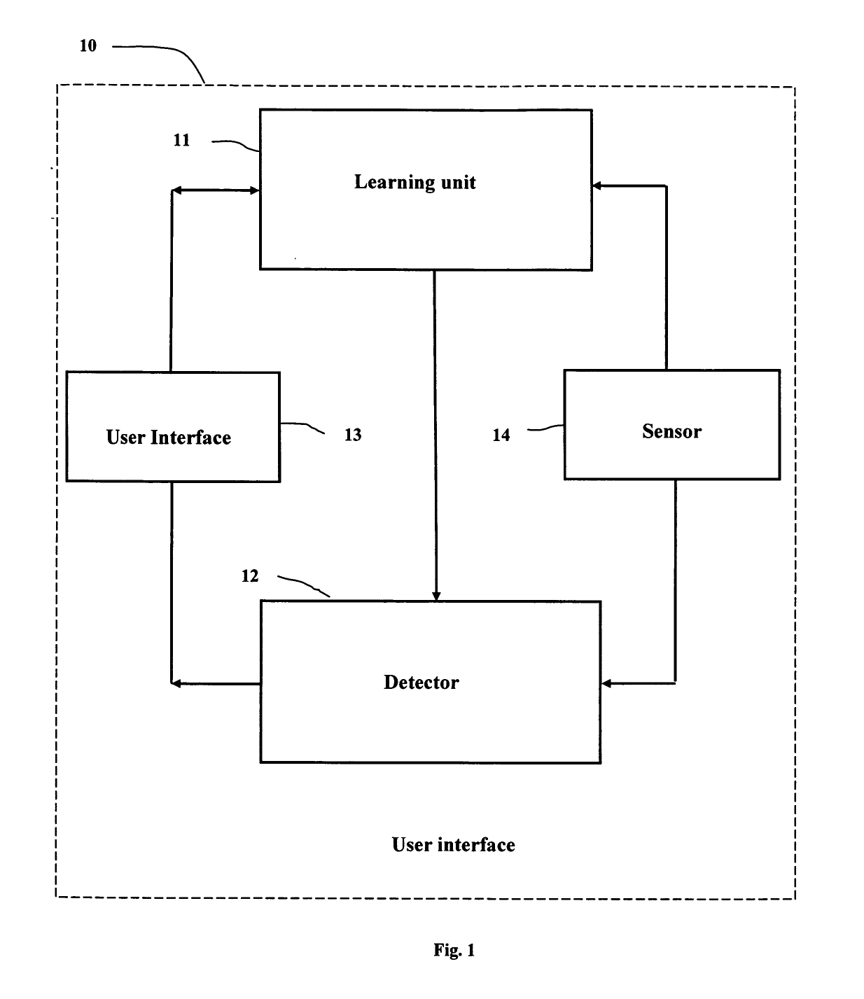

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose Reference is now made to FIG. 1 which is a block diagram of the user trainable detection apparatus. The apparatus 10 comprises a detector 12 (also called: user detector). The detector receives input from a sensor 14 and provides output to the screen of the user interface 13 (also called: GUI)). A learning unit 11 (also called: learning detector builder) receives as an example an input digital data derived from a signal of a sensor 14, which is labeled (marked) by the user through the user interface (GUI). The labeled input data example is used by the learning unit to output a set of classifiers to the detector. The set of classifiers is used by the detector to derive an instance output. The real data examples are labeled by the user according to the various event classes. Labeling is carried out through the user interface. The learning unit analyzes the labeled examples of input data and iteratively changes the classifiers passed to the detector for a pre-defined event detection operation. The learning process goes on until the user ceases entering real data examples when detection performance of the apparatus is satisfactory, but may be continued at any time, for example when circumstances change. The classifiers created by the learning unit during the learning process, are used by the detector during normal operation. The learning unit may be repeatedly operated at any time during the operation of the apparatus, by the user entering and labeling additional real data examples. As a result the classifiers are further adjusted. This feature can be used as a pseudo re-calibration tool for allowing the detecting apparatus to adjust to changing conditions at the detection site or the changing nature of detected cases. The learning process conducted initially or when the apparatus is operating, is carried out at the user site.

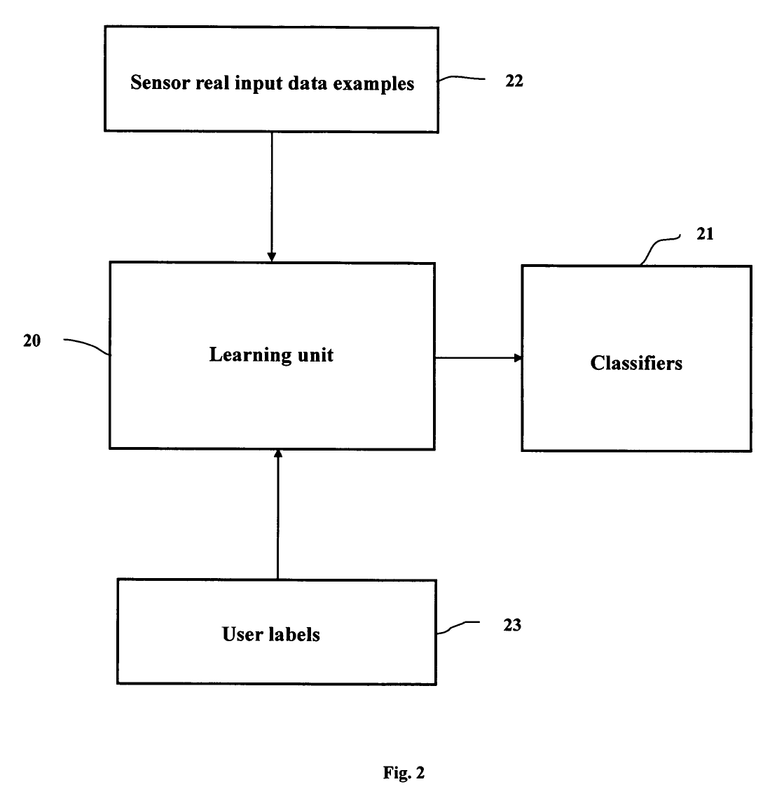

Reference is now made to FIG. 2 which is a block diagram of the learning unit structure. The learning unit 20, is used to create classifiers 21 by accepting sensor real input data examples 22 and user labels 23 added to the real input data. The detector uses the set of classifiers resulting from use of the learning process. The real input examples preferably include data derived from the sensors, which are then labeled by the user according to a class defined with respect to the detection problem. The learning unit analyzes the labeled examples to create a set of classifiers. Classifiers are used by the apparatus for detecting new events based on the previously entered examples. The user assisted (also called: supervised) learning technique may use for learning any number of examples determined by the user. Each new example entered by the user is used iteratively to fine tune the classifier set and yield improved system performance. The user may decide to end the learning process when the detecting apparatus reaches an adequate level of performance. The user may repeat the learning process at any time during the apparatus operation, by adding and labeling new examples to the detecting apparatus. This feature is used to upgrade detector operation by further adjustment of classifiers or to re-calibrate the detecting apparatus when conditions change or when different detection cases emerge.

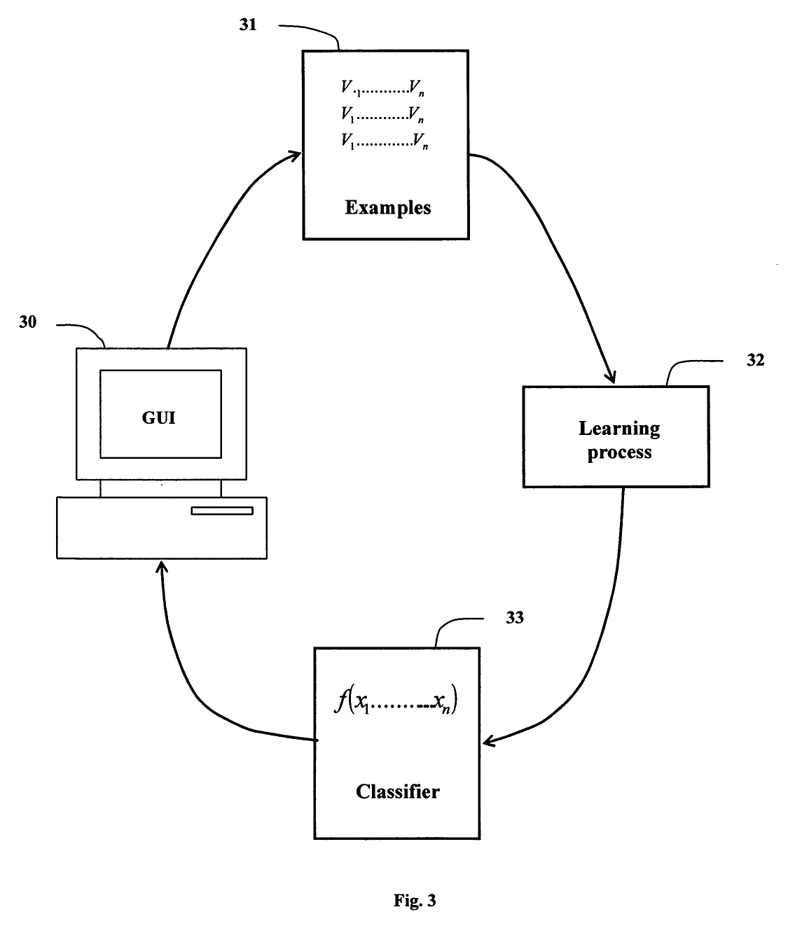

Reference is now made to FIG. 3 which is a block diagram of the learning cycle. A set of examples 31 defined as n dimensional vectors V₁ . . . Vₙ are fed into the learning process 32 by the GUI of the system 30. Each example entered is labeled by the user according to the input example class of event. The learning process 32 creates a classifier 33 based on the labeled input and expressed mathematically as a function: f(X₁ . . . Xn). The classifier is used to detect a new input example. The user provides feedback to the system, through the GUI, marking a detected example as right or wrong. The learning process modifies the classifier according to the added labeled input example and the cycle repeats as long as the user provides input examples to the system. During this learning process, the classifier fine tunes iteratively and enhances the detector performance. The user may bring to an end the learning cycle when the system performance seems satisfactory. The classifier at the end of the learning cycle is used by the detector during normal operation.

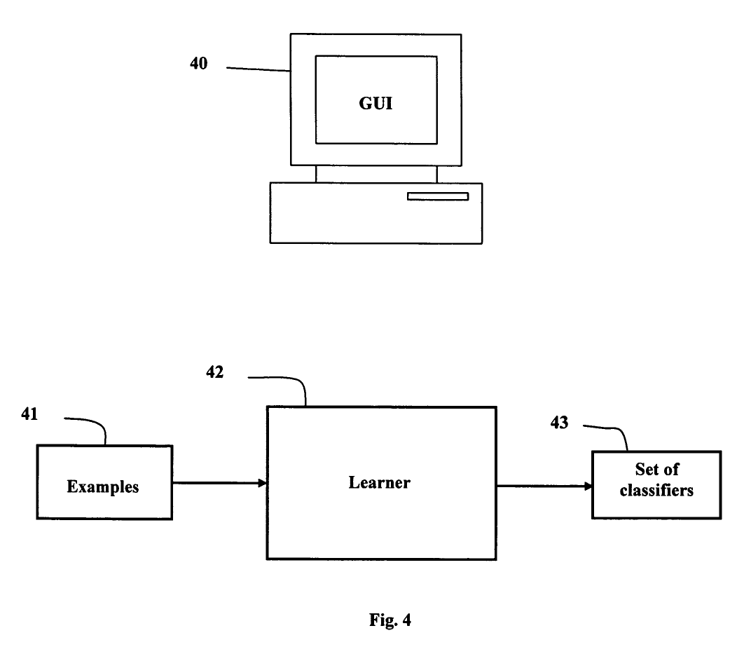

Reference is now made to FIG. 4 which is a block diagram of the Learning Detector Builder (also called: learning unit), which carries out the learning cycle explained in the preceding section. The GUI 40 is used when required by the user to enter a set of examples 41 from a sensor and label them. When a labeled example is entered by the user, the learner 42 creates a set of classifiers 43. The classifiers created at the end of the learning process, are used by the detector during normal operation to split the output of the detector according to the different classes of the detected events. Classifiers may be further adjusted by repeating the learning cycle when required and entering additional labeled examples

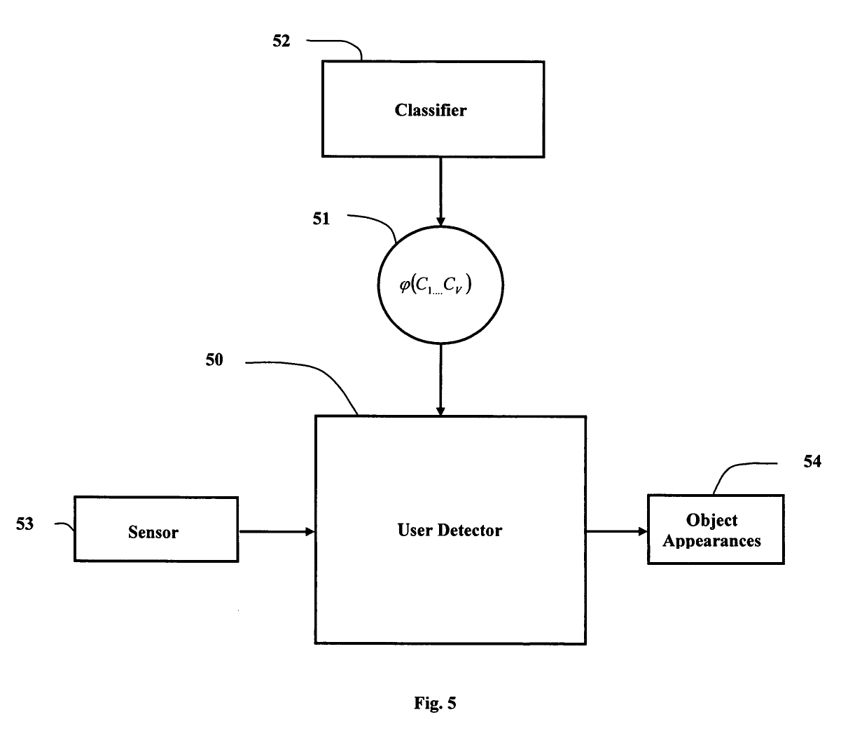

Reference is now made to FIG. 5 which is a block diagram of the user detector according to one embodiment of the invention. The user detector 50 is connected to a sensor 53, which may be a video sensor, an audio sensor or any available sensor. The classifier (or combination of classifiers) 52 represented by the classifier function 51, is generated by the learning detector builder, during the learning process, as described above. The classifier is used to determine object appearances output 54. The detector embodiment depicted in FIG. 5 is operates with a single sensor yet is not limited to operate with a single sensor.

In another embodiment, a substantially unlimited number of sensors may be used. For example, an event may be defined in a security system by a suspicious noise and a certain color car combined. Audio and video sensors may be applied jointly for the detector. The learning process and the operation of the detector comprising multiple sensors would be similar to the embodiment comprising a single detector.

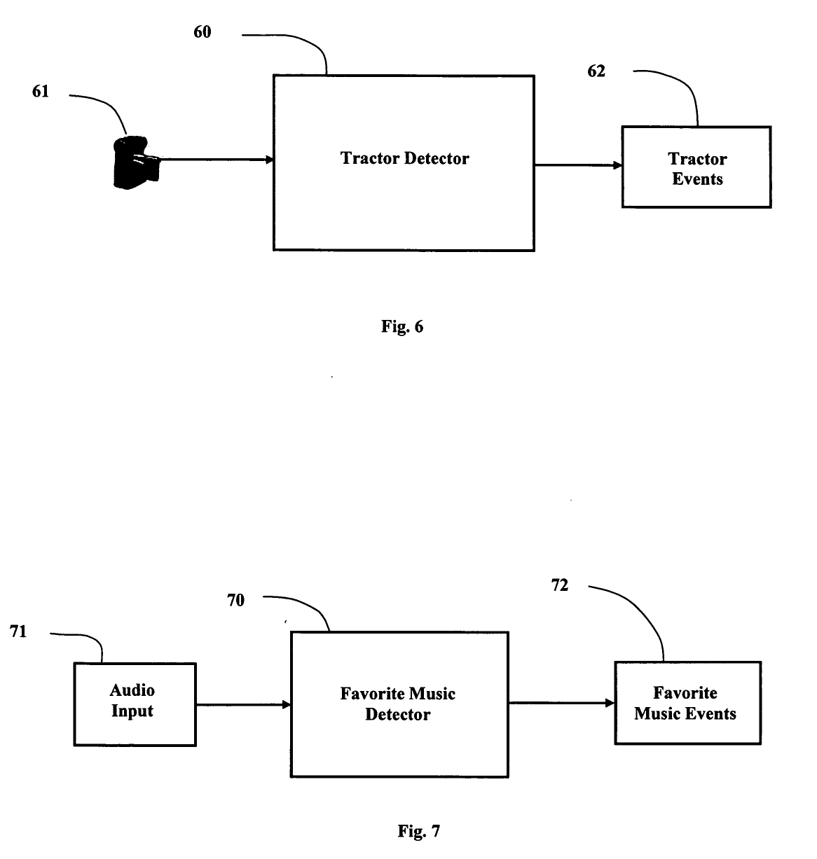

Reference is now made to FIG. 6 which is a block diagram of an example of the use of the detector as a tractor detector. The tractor detector 60 receives an input from a video camera sensor 61 and has to inform detected tractor events 62. The video camera may be directed at an industrial area including a traffic circle and a construction site. The user wants to be informed by the detector when a tractor is working at the construction site. Initially, there is no labeled input data and therefore no classifier output. Thus the tractor detector does not function effectively. The tractor detector is trained by the user entering tractor and non-tractor labeled examples to create the proper classifier. When the detector robustly detects the presence of a tractor in the scene, the user may cease the detector's training cycle.

The example discussed in the preceding section describes a user detector comprising a video camera sensor. The user detector operation is by no means limited to video sensors. Another embodiment of the invention discussed in the subsequent section concerns a user detector configured with an audio sensor to create a favorite music detector.

Reference is now made to FIG. 7 which is a simplified block diagram illustrating a favorite music detector according to another embodiment of the present invention. An audio input 71 is connected to the favorite music detector 70 which outputs favorite music events 72 categorized as jazz, rock, classical music or other types of music. Initially the detector does not have a set of classifiers and is incapable of detecting any musical events. The learning process begins with the user labeling through the GUI, examples of different styles of music entered through the audio input. The audio signal of the labeled music examples is analyzed by the learning unit in order to create a set of classifiers. Subsequently the favorite music detector is able to identify when the user's favorite music is played. The user can evaluate the performance of the favorite music detector and decide to continue entering favorite music examples. He may thus enhance the favorite music detector performance by iteratively fine tuning the set of classifiers using the additional examples. When the evaluated performance of the favorite music detector is satisfactory, the learning process is brought to an end.

A description is provided herein with further detailed explanation of the mode of operation of the system units, including mathematical analyses and various embodiments and techniques used in the learning process. GUI here is only example of possible GUI, Not necessary rectangle, other object marking types such as ellipse, free hand are also optional.

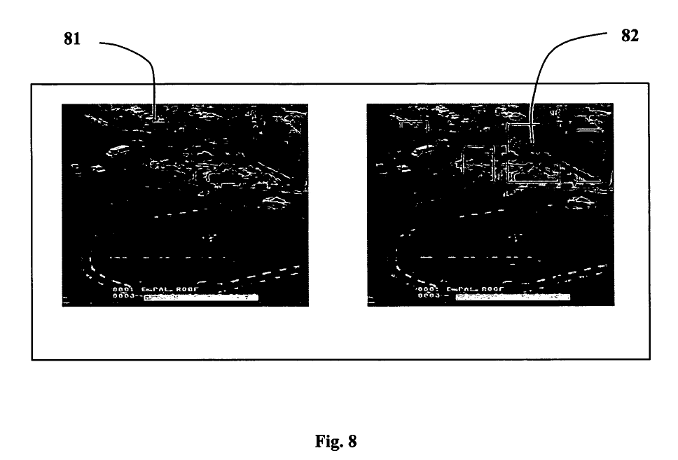

Reference is now made to FIG. 8 which illustrates user labeling via the GUI in the tractor detector example. The GUI screens of the initial step of the tractor detector learning process are illustrated. Rectangle 81 used as an indicator illustrates a user entering an example of positive data (tractor), multiple rectangles 82 illustrate negative data of objects which are not a tractor (non-tractor).

The rectangles used in this example and the following examples as indicators do not have to be necessarily rectangles. Other indicator shapes may be used such as: circles, ellipses, triangles and more, including freeform shapes, and more generally, any indicator can be used that clearly indicates both to the user and to the system the boundaries of an object of interest.

The GUI screen (a) illustrated on the left side, is used to label, by the user, a tractor event, a tractor event meaning that a tractor is present at the scene. A tractor present at the scene is surrounded by a rectangle and the user enters the data that the object defined by the rectangle is a tractor, so that both the presence and the location of the tractor are clearly made known to the system. The GUI screen (b) illustrated on the right side is used by the system to label non-tractor events. Labeling non-tractor events is implemented by rectangles surrounding various non-tractor regions in the scene and user entering the related information to the tractor detector. The system learns the tractor and non tractor labeled examples and creates a set of classifiers used to differentiate between tractor and non-tractor events. The created classifiers are used by the tractor detector to identify the presence of a tractor in the scene. Tractor detector performance shown is still limited due to the small number of labeled examples used by the system to create the set of classifiers. Performance can be substantially improved by the user entering additional labeled examples and the system iteratively fine tuning the set of classifiers.

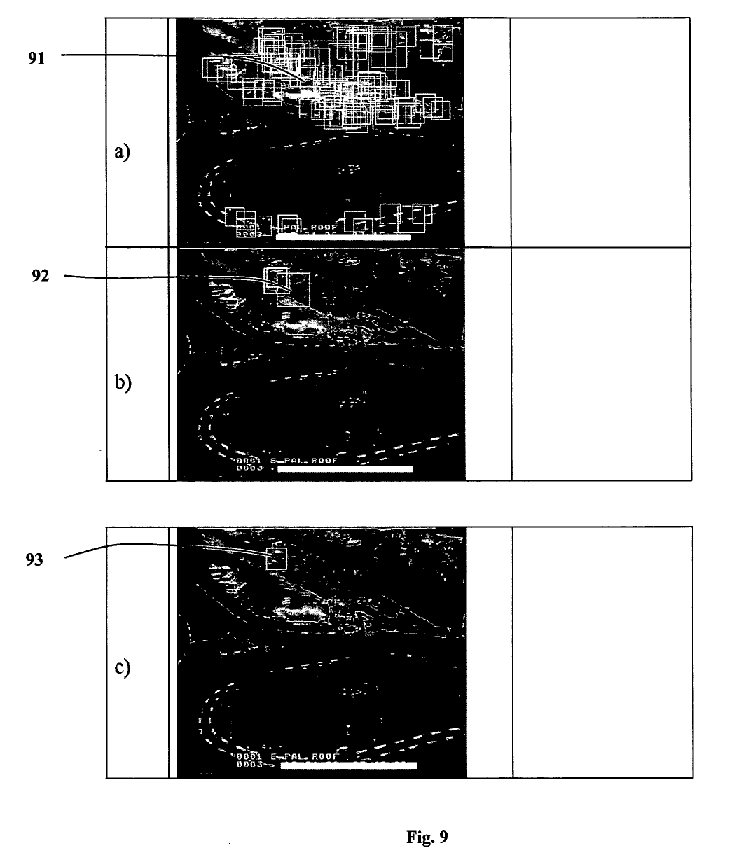

Reference is now made to FIG. 9 which is an illustration of GUI screens showing the tractor detector output for different performance levels cases. The shown performance levels of the tractor detector have been reached by different sets of examples used by the learning process. Three screens 9a-9c represent three phases in system performance and white rectangles indicate detection of a tractor in the scene.

Screen (a) depicts the tractor detector performance for a case in which 31 positive tractor examples and 71 non-tractor examples have been entered by the user in the learning process. The multitude of white rectangles 91 in the scene, indicates a low performance level of the tractor detector in this case, since many rectangles do not include tractors. Evidently, the number of labeled examples needs to be increased substantially.

The low number of example is purposely selected to show how by increasing the number of examples the learning process converges, as depicted in screen a and screen b.

Screen (b) depicts a later phase in which the number of positive examples 31 is identical to the previous case, while the number of non-tractor examples entered is increased substantially to 1577. Rectangles 92 indicate a substantial improvement in the tractor detector performance yet some wrongly detected events are still shown.

Screen (c) depicts the tractor detector performance for the case that the number of positive tractor examples is 42 while the number of non-tractor examples is further increased to 1897. Rectangle 93 illustrates a satisfactory level of performance. The single tractor present at the scene is correctly detected and the rest of the scene does not show any wrongly detected tractor.

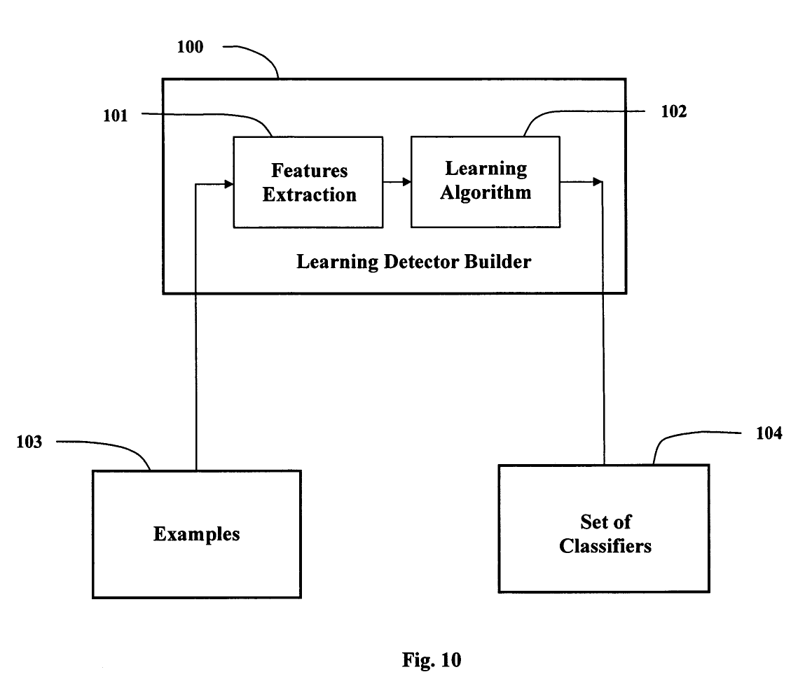

Reference is now made to FIG. 10 which is a block diagram of an embodiment of the learning detector builder (also named: Learning unit). The Learning detector builder 100 accepts a set of examples 103 entered and labeled by the user. The learning detector builder comprises a feature extraction module 101 which extracts features from the input data and passes the features to the learning algorithm block 102, which derives from the features and outputs a set of classifiers 104. The set of classifiers is used by the apparatus to determine a detected event for a sensor input. Classifiers are updated iteratively for every additional sensor digital input entered and labeled by the user.

Features are characteristics of the sensor signal, determined by the kind of sensor and the category of the detection problems. The feature extraction module of the preferred embodiments are general and capable of extracting features from any kind of sensor and for any given detection problem. The general feature extraction module can be applied to any examples of sensors, signals and features including but not limited to the following:

1. Light intensity of image pixels.

2. Chrominance (color data) of image pixels.

3. Gradients of pixels.

4. Vertical gradients

5. Horizontal gradients

6. Sum of oriented gradients

7. Image flow information.

8. Inter-motion of an object.

9. Disparity map.

10. Object width.

11. Object height.

12. Object location coordinates.

13. Region of interest.

14. Background image.

15. Image of change.

16. Image of differences.

17. Image of labels.

18. Image of segmentations.

19. Illumination information.

20. Texture/pattern information.

21. Object counter in time segment.

22. Event counter.

23. General counter.

24. Geometric relationship of objects.

25. 3D information

26. Epipolar plane image.

27. Moments of various orders.

28. Geometry information of the scene.

29. Object symmetry level.

30. Signal noise level.

31. Noise level of non-rigid objects.

32. Kalman filter equations assignments' results.

33. Condensation filter equations assignments' results.

34. Filtered image by a Low Pass Filter (LPF).

35. Any filtered image.

36. Object trajectory.

37. Shape of an object trajectory.

38. Trajectory shape.

39. Relationships of several objects' trajectories.

40. Combinations of cameras.

41. Distances from a camera.

42. Infra-Red (IR) information.

43. Eigenvalues of an image.

44. Eigenvalues of any image transformation.

45. Velocity.

46. Acceleration.

47. Zoom.

48. Global Positioning System (GPS).

49. Statistical information.

50. Discrete Cosine Transform (DCT) coefficients.

51. Fast Fourier Transform (FFT) coefficients.

52. Walsh-Hadmard transform.

53. Haar transform.

54. Wavelet transform.

55. Hough transform.

56. Image transformation to other spaces.

57. Azimuth.

58. Elevation.

59. Slant range.

60. Downrange.

61. Radar altimeter (measures altitude from a satellite to the surface of the earth).

62. Suspicious object detection alert.

63. Object removal alert.

64. Directional motion detector alert.

65. Tracking detector output.

66. Camera tamper detector alert.

67. Audio activity detector alert.

68. Smoke detector alert.

69. Irregularities detector alert.

70. Information about related events in two different cameras.

71. Speech pattern recognition.

72. Face recognition.

73. License plate recognition.

74. Male/Female distinction.

75. Any recognition problem.

76. Time of appearance.

77. Time from last appearance.

78. Image histogram.

79. Audio histogram.

80. Audio pitch.

81. Any discrete data histogram.

82. Audio information

83. Stereo audio information.

84. Audio transformation to other spaces.

85. Dynamic range of audio signal.

86. Audio signal duration.

87. Textual information.

88. Ultrasonic information.

89. Input from an access control system.

90. Manual input.

91. Temperature.

92. Humidity.

93. Wind speed.

94. Smell.

95. Taste.

96. Chemical scene information.

97. Geographical heights map.

98. Database information.

99. Current weather.

100. Current climate.

101. Barometric pressure sensor.

102. X ray machine image.

103. CT image.

104. MRI image.

105. Single Photon Emission Computed Tomography (SPECT) image.

106. ECG sensor.

107. EEG sensor.

108. PH sensor.

109. Blood pressure sensor.

110. Fat percentage.

111. Carbon monoxide sensor.

112. Charge sensor.

113. Compass sensor.

114. Electro smog sensor (measures electric field strength).

115. Force-meter sensor.

116. Magnetic field sensor.

117. Air pressure sensor.

118. Geiger sensor.

119. Rotational movement sensor.

120. Volume sensor.

121. Vibration sensor.

122. IR distance measurement sensor.

123. UV irradiance sensor.

124. Microwave sensor.

125. Oxygen sensor.

126. Voltage sensor.

127. Acoustic field sensor.

128. Biomedical sensor.

129. Actinometer (measuring acitinic action in radiant energy).

130. Breath analyzer.

131. Fingerprints information.

132. Biometrical information.

133. Polygraph.

134. Relationships of various features.

135. Statistical data of features or combined features.

136. Any sensor having discrete output or having an output that can be converted to discrete output.

137. Future developed sensors.

138. Frequency of a word in a document.

Initially, a large number of features may be extracted during feature extraction. Some of the features are most likely not used by the classifier for the following reasons:

1. High correlation between features, which brings about redundancy of some of those features.

2. Some of the features are redundant by not being relevant to the current detection problem. For instance: direction of motion information may be extracted as a feature although it is not relevant to the detected event since the user in the specific case is only interested in moving object in any direction data. Thus, the motion data can be discarded as irrelevant in the learning phase. Features used during detector operation are identical to the features used during the learning process, thus feature reduction at the learning phase, that is identification of features that remain unused, can be used to identify features that do not need to be detected during the detection phase and may significantly enhance detector speed by reducing processing time. Reduction in the number of features can enhance the performance of the apparatus by creating a coherent non-redundant set of features.

3. Reduction in the number of features may be implemented mathematically by an n-dimensional orthogonal space of dimension smaller than the number of features and projecting the set of features onto the space so that correlated parts of features, which are redundant, can be removed. Some of the known feature dimensional reduction techniques are: Principle Component Analysis (PCA) and Linear Discrimination Analysis (LDA).

In the embodiment, depicted in FIG. 10, the learning algorithm applied is categorized as a supervised machine learning technique. Supervised machine learning is a semi automatic learning technique wherein the user enters input data examples and labels the examples according to the defined detection problem. The output of the learning algorithm is a set of classifiers which can predict the classes of the detected inputs. The number, variety and relevance of the examples to the detection problem, affects the capability of the set of classifiers to correctly detect data input.

A training set of n labeled input examples may be described as the following vectors:

((x₁,Y₁), (x₂,Y₂) . . . (xₙYₙ))

wherein,
xᵢ is a feature vector

and
Yᵢ is a related class label
i is an index associated with an example of entered data and each input vector k is the length of the vector, i.e. each xi is of length k.

The set of labeled examples are used by the learning algorithm to generate a hypothesis H which for a given length of a new input vector xᵢ minimizes the probability of error while classifying the new (unseen before) input vector. Meaning, data input classification has a high probability of being correct.

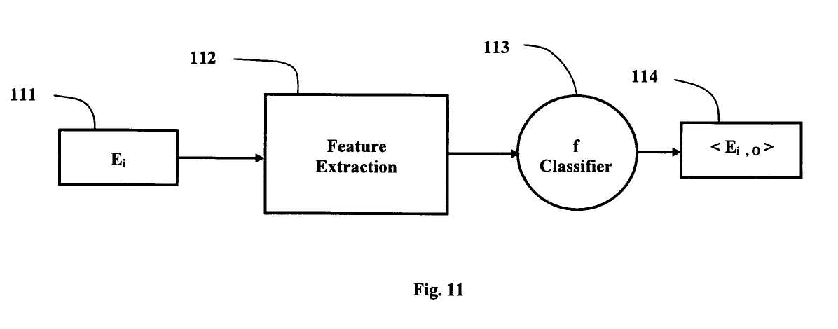

Reference is made to FIG. 11, which is a block diagram of the element process. Input data 111, is connected to the feature extraction block 112. Extracted features output is connected to the input of classifier block 113, which outputs the classes 114 of the input data.

Feature extraction operation is applied to get the relevant list of features:

<F₁ . . . Fₘ>

Let Vₜ be all the relevant data at time t.

ψ(C₁ . . . C_{V}) is a single classifier or a combination of several classifiers.

The extracted list of features, operating on every data input element, preserve the vector convention and the order of the learning process.

Let ƒ=ψ(C₁ . . . C_{V}) be the output of the classifier.

The function f is defined as:

ƒ:[ [symbol] F₁ . . . Fₘ [symbol] ]→[ [symbol] Eᵢ,O [symbol] ]

wherein

[symbol] Eᵢ,O [symbol] is the classification of Eᵢ to the object O.

The final output of the detector is a list of pairs:

[symbol] [symbol] Eᵢ₁,O₁ [symbol] , . . . , [symbol] E_{iq},O_{q}

[symbol]

[symbol]

where Oᵢ is the object type and Eᵢⱼ is the element which was classified as an instance of Oᵢ.

The list of features <F₁ . . . Fₘ> are entered to the function f.

Consequently the user detector classifies Eᵢ to be the instance of the object O.

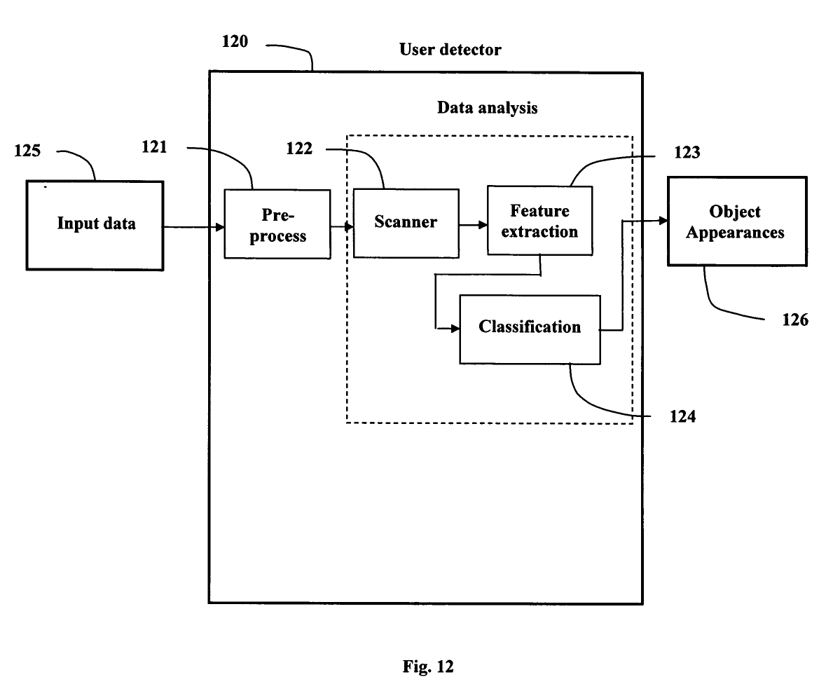

Reference is now made to FIG. 12 which is a block diagram of the user detector 120.

The input data 125 is pre-processed in block 121. Example of such a pre-process can be scaling of the input data. The pre-processed data is scanned by a scanner 122. A feature extraction block 123 extracts the features of the input data and the classifier block 124 outputs the detected object appearances 126.

The input data may come from various sensors and include a variety of signals and information, such as: video, audio temperature etc. The output of the user detector tells whether an instance of predefined events, have been detected. Detection is made by testing the features of the input data according to a classifier created by the Learning Detector Builder (also called: learning unit) during the learning process.

For a video sensor typical pre-processing entails scaling so that objects of different dimensions can use the same classifiers.

In another embodiment, hierarchical learning may be used for the detector, meaning that the learning process comprises at least two hierarchical levels. The first level of the detection problem is lower in hierarchy than the second level. For instance, a taxi detector can be implemented by building a car detector in the first level of the hierarchy and than building a taxi detector in the second level of the hierarchy so that the taxi detector is operational only when the car detector detects a car. A multiplicity of hierarchy levels may be used for hierarchical learning and any learning technique may be used.

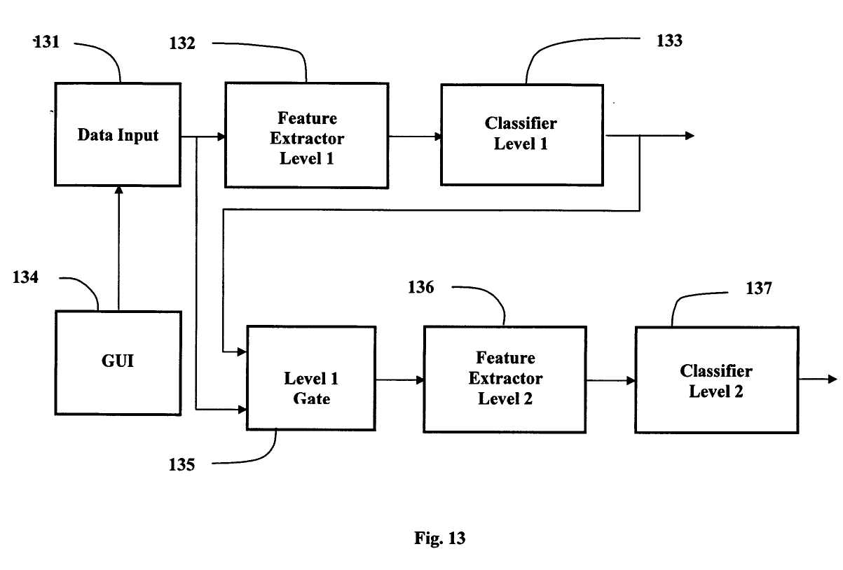

Reference is made now to FIG. 13 which illustrates a block diagram of the hierarchical learning process. During the learning process, digital data input 131 is entered into feature extractor level 1 132 and labeled by the user via the GUI 134. The output of any of the feature extractor level 1 enters classifier level 1 133. The output of classifier level 1 can be used by the detector as level 1 event detector and is also connected to level 1 gate 135 for gating data input flow into feature extractor level 2 136. Therefore, feature extractor level 2 is only operable when level 1 event is detected. Data input comprising labeled examples during learning process or real event data during detection, enters also into level 1 gate which lets the data pass through only when level 2 is active. The output of level 1 gate is connected to feature extractor level 2 and the output of feature extractor level 2 is connected to the classifier level 2 137. Classifier output is used by the detector to determine the detected event.

The learning process starts with the user providing labeled data examples, entering feature extractor level 1, sending the extracted features to the classifier level 1 and repeating the process iteratively until level 1 hierarchy learning process is reaches an adequate detector performance. The output of level 1 classifier can be used for a level 1 event detector or used jointly with level 2 to detect instances associated with level 2 detection problems. During level 1 learning process, level 1 gate is closed and does not allow data input flow into feature extractor level 2. When level 1, learning is done, data input examples are entered and labeled by the user similarly to level 1 learning process. Only events that have been detected by level 1 are used in the learning process of level 2 by classifier level 1 opening gate level 1 and allowing data input to flow into feature extractor level 2. In the detector implementation only events detected by classifier level 1 and classifier level 2, are detected. As with non-hierarchical learning, the learning process is iteratively fine tuning the detector.

There are several techniques of learning algorithms known in the literature, including: AdaBoost, Neural network and Support Vector Machine (SVM) that are discussed in the subsequent sections. Each of the above methods (and also other known supervised methods) can be used for being the learning algorithm.

AdaBoost refers to a general method of producing a very accurate prediction rule by combining rough and moderately inaccurate rules of thumb. The boosting principle is based on the observation that finding many weak classifiers by rules of thumb is easier than finding a single strong classifier. The performance of weak classifiers is defined as being somewhat higher than a random results generator. During the learning process, AdaBoost maintains a set of weights over the training set. Initially all weights are set equal, but each round, the weights of incorrectly classified examples are increased so that the learner is forced to focus on the hard examples of the training set.

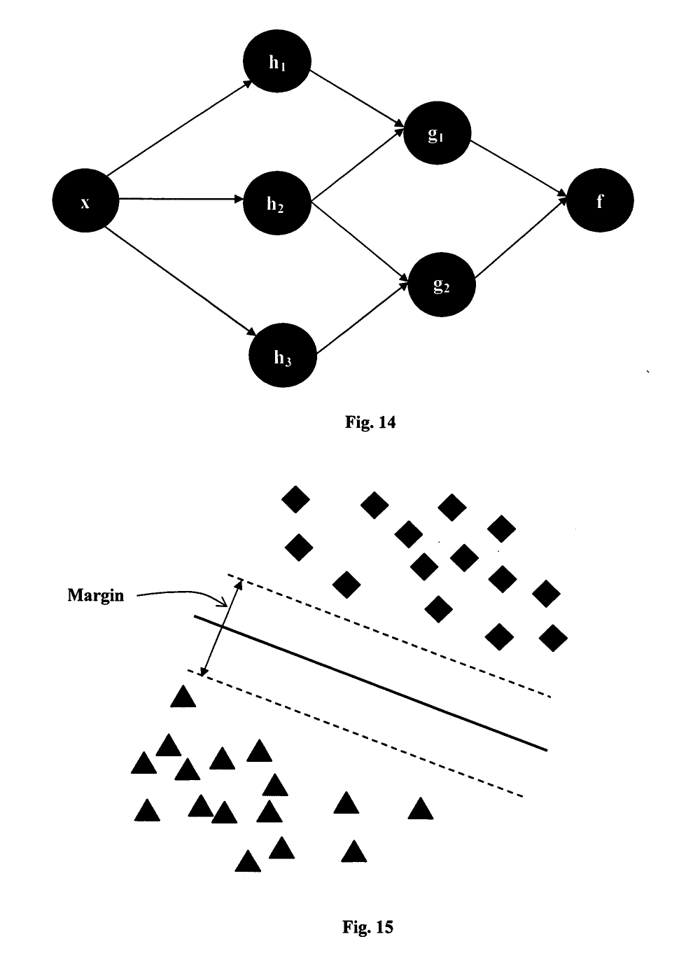

Another learning machine algorithm is the ANN depicted in FIG. 14 which illustrates an Artificial Neural Network (ANN) dependency graph. Four layers of nodes are illustrated:

X is the input layer.

hᵢ(x) is the second layer.

gᵢ(x) is the third layer.

ƒ(x) is the output layer.

The function ƒ(x) is defined as a composition of functions gᵢ(x) while functions gᵢ(x) are defined as a composition of functions hᵢ(x).

The arrows depict the dependencies between variables as following:

h₁, h₂, h₃ are dependent on x.

g₁ is dependent on h₁ and h₂.

g₂ is dependent on h₂ and h₃.

f is dependent on g₁ and g₂.

One function used typically in ANN is a nonlinear weighted sum function. The most interesting feature of neural networks is the capability of learning, which in practice means: Given a specific task to solve, and a class of functions F, learning means using a set of observations, in order to find ƒ*εF which solves the task in an optimal sense. The cost function is an important concept in learning, as it is a measure of how far away we are from an optimal solution to the problem that we want to solve.

Neural network based learning algorithms search through the solution space in order to find a function that has the smallest possible cost. For applications where the solution is dependent on some data, the cost must necessarily be a function of the observations otherwise we would not be modeling anything related to the data. It is frequently defined statistics to which only approximations can be made.

One more example of learning machine is the SVM depicted in FIG. 15 which is a Support Vector Machine (SVM) example. FIG. 15 illustrates a detection problem of separating square objects from triangular objects. Separation is implemented by a hyperplane illustrated as a solid line wherein every detected square object falls above the line and every detected triangular object falls under the line. Two dashed lines one above the solid line and another below the solid line, determine the minimum distance between the set of square objects and the set of triangular objects. The distance between the dashed lines is marked as “margin”.

Support Vector Machines are learning machines that can perform classification tasks base on real valued function approximation utilizing regression estimation. Support Vector Machines non-linearly map their n-dimensional input space into a high dimensional feature space. In this high dimensional feature space a linear classifier is constructed.

An N dimensional hyperplane is constructed by the SVM to separate the data into two or more categories. The hyperplane separates the data points with maximum distance to the closest data point from both classes. This property is substantially significant for yielding a high performance general detecting apparatus. A non linear classifier can be generated by applying a kernel function to maximum-margin hyper planes. The algorithm is similar to the general SVM algorithm except that the original dot products are replaced by the non linear kernel functions.

Any of the learning techniques and any combination of the learning techniques, discussed in the preceding section, are appropriate as embodiments of the detecting apparatus. Furthermore, embodiments are not restricted to the techniques discussed and may comprise various combinations of the learning techniques.

There are common schemes that the learning methods can use in order to improve the learning process and the learning product, e.g. a rejection scheme and a cascade scheme. In the cascade scheme the algorithm constructs a cascade of classifiers which achieves increased real-time performance. Smaller, more efficient boosted classifiers can be constructed in a way that rejects many of the negative instances while detecting almost all the positive instances. Stages in the cascade are constructed by using a learning machine for training classifiers. Starting with a small number feature strong classifier, an effective detection can be obtained by adjusting the strong classifier threshold to minimize false negative detection instances. The initial threshold is designed to yield low error rate on the training data Based on the performance measured using validation training set. The detection performance of the two feature classifier is not adequate yet at this point and the process continues by finding a new rejector every new iteration, i.e. a new classifier that will reject a lot of examples while keeping on a small number of miss detections.

The overall training process involves two types of tradeoffs. In most cases classifiers with more features are likely to achieve higher detection rates and lower false alarm positive rates. At the same time, classifiers with more features require more computation time. Therefore, the number of classifier stages, the number of features of each stage and the threshold of each stage, has to be traded off to reach a satisfactory optimization level.

A rejection scheme can be used by the learning unit to improve the learning process. The rejection scheme rejects substantially certain non user objects at an early stage of the learning process, while hard to detect examples which cannot be classified easily by the user, pass the rejection scheme.

The present embodiments comprise an apparatus and a method for detecting events. The apparatus is configurable by a learning process applied on site with real input data labeled by the user. A single platform can be configured to execute effectively various detection tasks with any number of sensors. The learning process can be applied at all times to enhance operation by entering new detection examples and adjust to varying conditions.

The following embodiments are used as examples for demonstrating the detector operation and performance. The results of each test example are presented as ordered pairs <Fⁱ, F^{j}> with rectangles in the detected areas. All of the presented results are based on test video captures which were not used in any step of the learning process. Training data sets are separated from test data sets, hence the presented examples have never been seen previously.

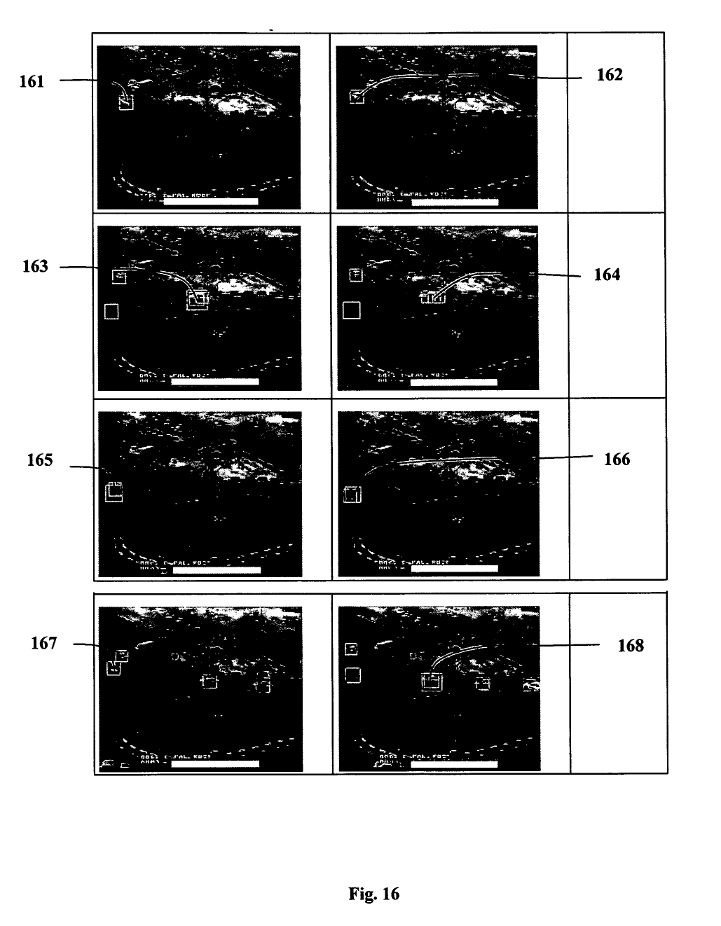

Reference is now made to FIG. 16 which is an example of a detector set up to detect a specific event. The specific event is that of a moving car as opposed to stationary cars or other vehicles or objects such as pedestrians whether stationary or moving. Data input is a video signal and detected event defines cars moving in any direction. A detected moving car in each case is marked by a rectangle. The illustrated images are referenced in a top down order. Rectangle 161 illustrates one moving car and rectangle 162 illustrates the same moving car one second later.

Rectangle 163 and rectangle 164 illustrate one out of three cars moving in different directions. The cars moving in different directions are detected while the static cars are not detected. The third pair of images illustrates a single moving car in a slightly different scene. Rectangle 165 and rectangle 166 illustrate the moving car at instances of one second apart while a moving motorcycle in the scene is not detected, and neither are the static cars. The fourth pair of images illustrates multiple detections of multiple moving cars in different directions. Rectangle 167 and rectangle 168 illustrates one of four moving cars in the scene at instances of one second apart. The example indicates the operation of the detector according to the definition of the detection problem. Only moving cars are detected, moving cars are detected regardless of the direction of movement and a motorcycle is not detected though it is moving.

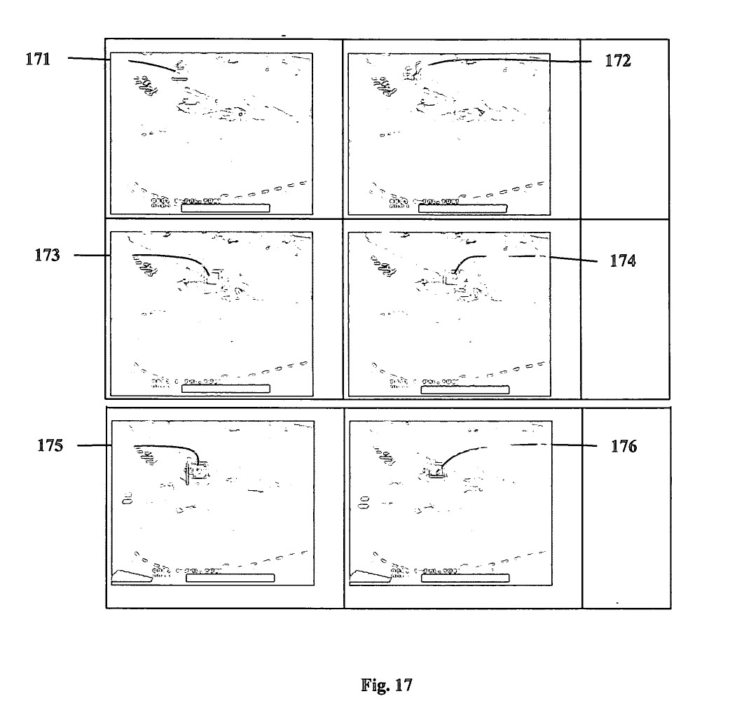

Reference is now made to FIG. 17 which is an example of a tractor detected event. Input data is a video signal. The detected event is a tractor at various locations and orientations. The illustrated images are referenced in a top down order. Rectangle 171 and rectangle 172 illustrate the detected tractor at two instances of four seconds apart. Rectangle 173 and rectangle 174 illustrate the detected tractor in a different position. Rectangle 175 and rectangle 176 illustrate in an orientation that is vertical to the orientation of the tractor illustrated in rectangles 171 and 172. Non-tractor objects are not detected as a tractor regardless of whether they are resting or moving.

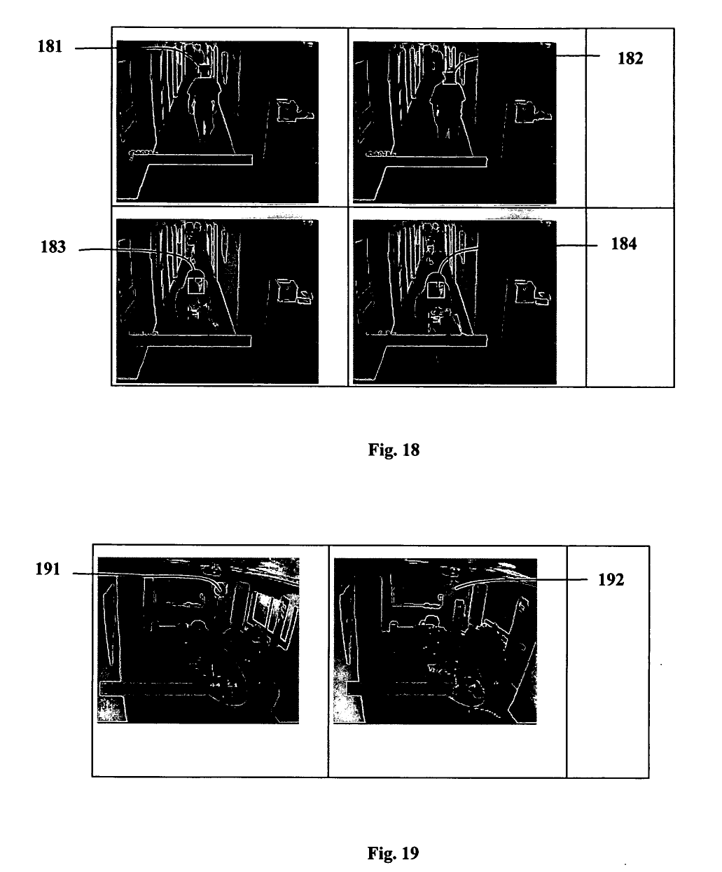

Reference is now made to FIG. 18 which is an example of a face detector. Input data is a video signal and detected output is people's face. A detected face is marked by a rectangle. The illustrated images are referenced in a top down order.

Rectangle 181 and rectangle 182 illustrates detection of a face included in the training set detected at two different instances a fraction of a second apart.

Rectangle 183 and rectangle 184 illustrate a detected face wherein the face is not included in the training set at two different instances a fraction of a second apart. The example indicates the face detector's ability to detect a human face even if it is not included in the training set.

Reference is now made to FIG. 19 which is an example of a clock theft detector. Rectangle 191 illustrates a clock hanging on the wall. The same place on the wall is illustrated by 192 when the clock has been removed from the wall. The missing rectangle in this screen implies that the theft of the clock has been detected.

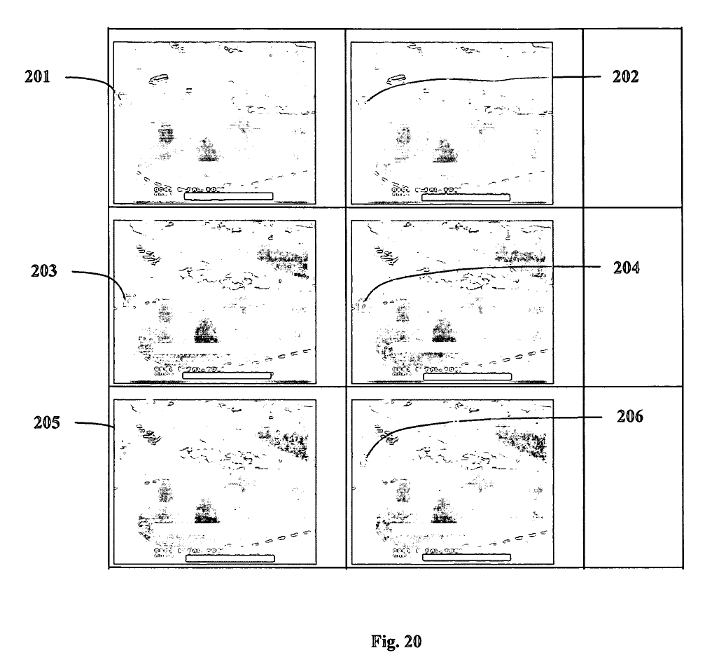

Reference is now made to FIG. 20 which is an example of a moving motorcycle detected event example. Rectangle 201 and rectangle 202 illustrate a detected moving motorcycle at two instances of one second apart while cars in the scene are not detected. Rectangle 203 and rectangle 204 illustrate a detected moving motorcycle while a moving tractor in the scene is not detected. Rectangle 205 and rectangle 206 illustrate a detected moving motorcycle while a moving tractor and a moving car are not detected regardless of the moving direction.

The detection apparatus according to the invention incorporates advantages including the following:

1. Training the detector at the user site and using real data examples yields a high performance robust detector and dramatically reduces the input space by using a reduced set of examples which have characteristics similar to the detected events.

2. Operational security is maintained since nobody excluding the user is involved in the learning process of the detection apparatus. The user does not have to expose the detector he wants to create.

3. Enables extremely fast detector creation.

4. Enables the user getting a detector for any object type he would want to detect.

5. Any detecting event specified by the user can be addressed regardless of the functioning requirements, the type of sensors and their kind including narrow fields which no one would have to devote time and money to develop.

6. Provide solutions for wide fields with performance and robustness that no other existing detector can provide.

7. The detector enables on site event detection adjustment capability during operation to enhance performance by adding new examples or adapting variations in the detection environment.

8. Allow widespread use of the apparatus by easily providing solutions to a wide range of detection problems.

9. Product development and maintenance substantial cost reduction by staying away from software development to address specific detection events or to modify an existing detection apparatus according to the user requirements.

10. Providing a cost effective solution to any kind of event detecting and hence allowing home users to take advantage of detection technology.

11. Allows the user to define his detector requirement and configure the detector according to his requirements.

12. Allows implementation of unique detection capabilities based on a multiplicity of different sensors.

13. The detection apparatus algorithm is independent of the platform used.

14. Standard input output interface easily adaptable to new sensors and third party applications such as smoke detectors, voice, smell, heat, video and more.

15. A standard output interface allows an easy connection to third party applications, for example: object recognition, control systems, automatic systems and more.

16. Easily adaptable to new sensor technologies.

17. Configuration by the user assures that the detection apparatus will perform adequately according to user requirements.

18. Multiplicity of detectors can be combined with the detector into a synergetic event detection apparatus.

19. Real-time event detection is provided.

20. User friendly through user interface

21. Standard Application Programming interface (API) allows easy integration with other components into a larger system.

The numerous advantages of the detection apparatus overshadow the drawback that the user does not have a finished product until it has been configured by him and that each time that a change is required his intervention is required.

It will be appreciated that the training system of the present invention may be used with a new detection apparatus or to improve an existing apparatus. That is to say the training system may be used to improve already learnt detection provided say from the factory.

It is expected that during the life of this patent many relevant devices and systems will be developed and the scope of the terms herein, particularly of the terms system network structure. It is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A user trainable detecting apparatus for on site configuration; said apparatus comprising:
at least one sensor;
a detector for detecting events in data from said sensor,
a user interface with labeling functionality, to enable said user to label, data from said sensor; and
a learning unit, associated with said user interface, to use said labeled data in an in-situ learning process to produce an in-situ learning result for use in said detector.

2. The trainable detecting apparatus in claim 1, operable to use said labeling for positive and negative identification of predefined events.

3. The trainable detecting apparatus of claim 1, operable to use said labeling to identify classes of events.

4. The trainable detecting apparatus in claim 1, wherein said user interface is further configured to use pre-recorded sensor data.

5. The trainable detecting apparatus in claim 1, wherein said in-situ learning result is iteratively refinable by allowing said user to access said user interface to take additional sensor data for labeling and sending to said learning unit.

6. The trainable detecting apparatus of claim 2, wherein said predefined events are multi-component events.

7. The trainable detecting apparatus of claim 1, comprising an application programming interface connecting said detector to said sensor and to external components.

8. The trainable detecting apparatus of claim 1, wherein said user interface is a Graphical User Interface (GUI).

9. The trainable detecting apparatus of claim 1 wherein said at least one sensor comprises a multiplicity of sensors.

10. The trainable detecting apparatus of claim 1, wherein said multiplicity of sensors comprises a plurality of sensors of different kinds, each kind detecting different events.

11. The trainable detecting apparatus of claim 1, wherein said multiplicity of sensors comprises a plurality of sensors of different kinds, each kind detecting aspects of the same event.

12. A user trainable detecting method comprising:
placing a sensor in situ;
obtaining from said sensor an initial set of real data
passing said initial set of data to a user interface,
at said user interface accepting user labeling of said data;
carrying out a learning process using said labeled data to produce an in situ learning result; and
using said in situ learning result to carry out recognition of further data obtained from said in-situ sensor.

13. The user trainable detecting method in claim 12, wherein said learning process comprises a supervised machine learning technique including feature extraction and classification.
